(19) United States
(12) Patent Application Publication
(10) Pub. No.: US 2026/0313292 A1
(43) Pub. Date: Oct. 8, 2026

(54) LOUDSPEAKER WITH PHASE PLUG

(71) Applicant: ASK INDUSTRIES SOCIETA' PER AZIONI, REGGIO NELL'EMILIA (RE) (IT)

(72) Inventor: Dario CINANNI, SENIGALLIA (AN) (IT)

(21) Appl. No.: 19/483,535

(22) PCT Filed: May 2, 2024
(86) PCT No.: PCT/IB2024/054233

§ 371 Date: Nov. 11, 2025

(30) Foreign Application Priority Data
May 16, 2023 (IT) 102023000009816

(51) Int. Cl. H04R 1/34; H04R 7/12; H04R 7/18; H04R 9/02; H04R 9/06

(52) U.S. Cl. CPC H04R 1/345; H04R 7/12; H04R 7/18; H04R 9/025; H04R 9/06; H04R 2201/34; H04R 2400/11

(57) ABSTRACT

A loudspeaker comprises: a magnetic assembly defining an air gap, a basket containing the magnetic assembly, a voice coil arranged in the air gap, a cylindrical support supporting the voice coil, and a diaphragm connected to the cylindrical support of the voice coil. The diaphragm is annular and has an outer edge connected to the basket and an inner edge around a central hole, and connected to a central support. The diaphragm has an annular channel with concave shape when viewed from above. The loudspeaker comprises a phase plug with annular shape arranged in the annular channel of the diaphragm so as not to interfere with the movement of the diaphragm.

The present invention relates to a loudspeaker with a phase plug of acoustic type, and specifically to a loudspeaker with an annular diaphragm for high-frequency applications, such as a tweeter.

U.S. Pat. Nos. 1,690,840, 2,058,208, GB619882, JP57053198, AT382281, and GB2099659 disclose loudspeakers with an annular diaphragm. In particular, U.S. Pat. No. 1,690,840 discloses a first annular diaphragm with a flat profile and with a straight V-shaped profile, GB619882 is among the first documents to disclose an annular diaphragm with a curved V-shaped profile, whereas JP57053198 discloses different solutions for both the straight profile and the curved V-shaped profile, and GB2099659 discloses a construction method of the V-shaped profile. In addition, U.S. Pat. No. 2,058,208 discloses the first curved annular diaphragm, and finally AT382281 discloses different solutions for the radii of the curved diaphragms.

Direct radiating loudspeakers provided with an annular diaphragm (i.e. a diaphragm that is open in the center) are impaired by an efficiency drop at high frequencies comprised between 18 kHz and 20 kHz. In order to solve such a drawback, the use of a central phase plug arranged at the center of the annular diaphragm, i.e. in the part wherein the annular diaphragm is open, is known.

U.S. Pat. No. 6,320,972, EP1351546, JP2007325075, GB2388488, and U.S. Pat. No. 9,560,452 describe loudspeakers with an annular diaphragm having a central phase plug with a substantially conical shape.

However, such loudspeakers of the prior art are impaired by several drawbacks. The central phase plug protrudes externally from the diaphragm; consequently, the loudspeaker has a high thickness in axial direction. Therefore, such a loudspeaker cannot be used in automotive applications, in which the loudspeaker must have a low thickness in order to be integrated into the vehicle body.

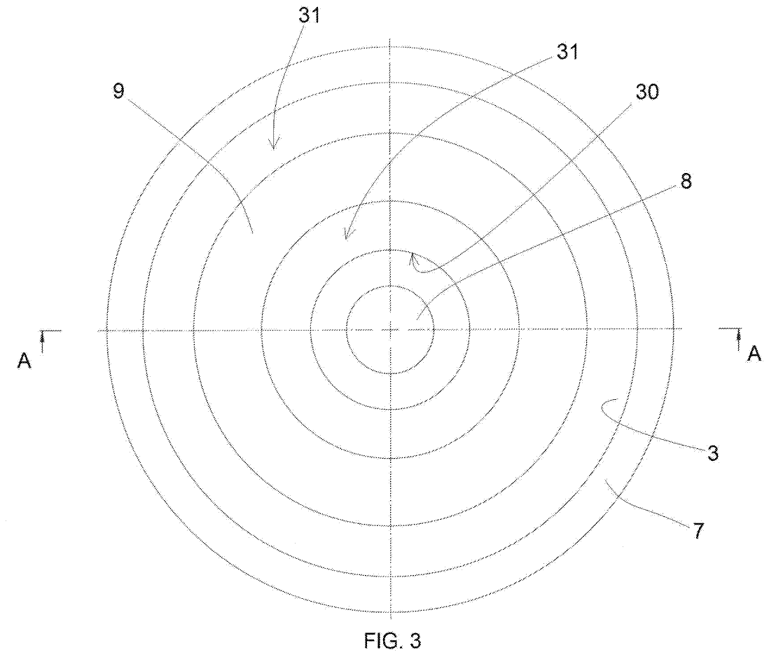

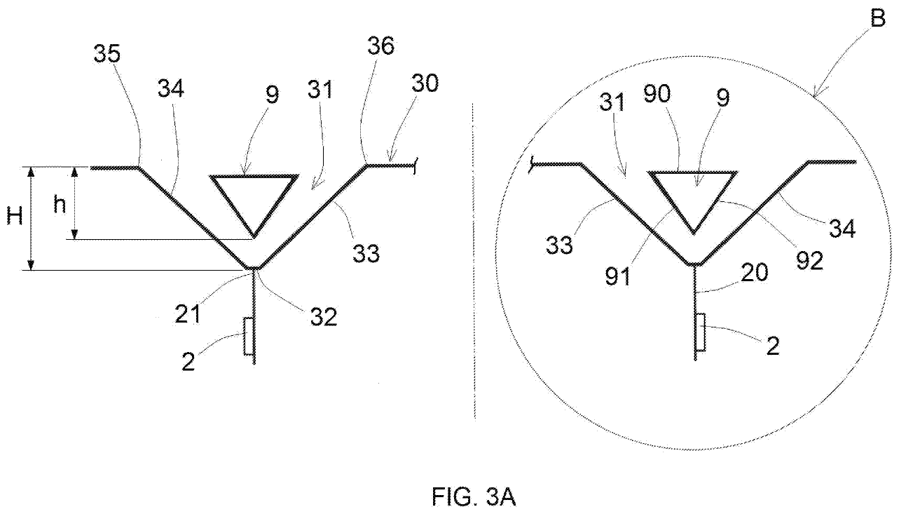

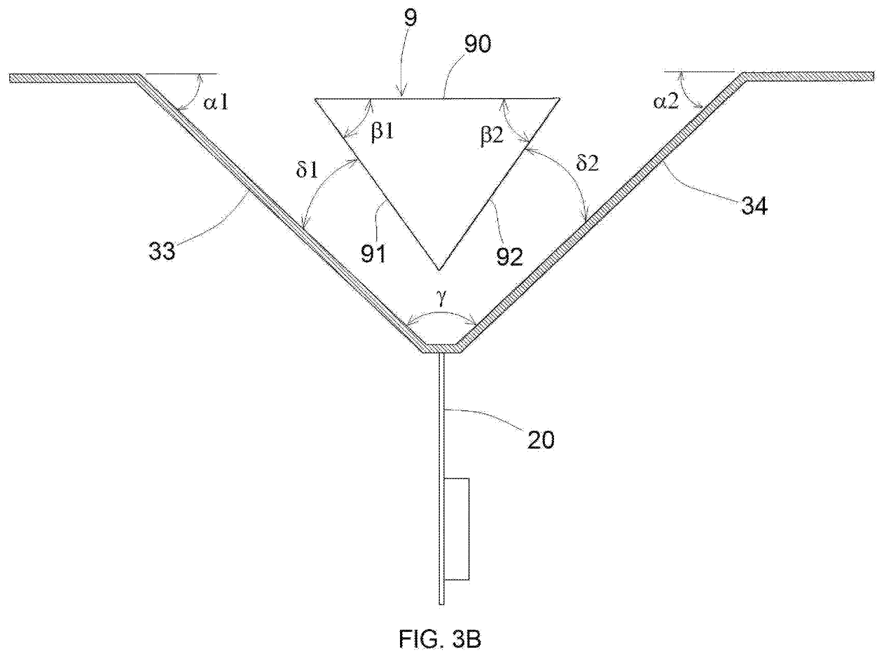

As shown in FIG. 3 of U.S. Pat. No. 6,320,972, the central phase plug increases the sound pressure level (SPL) in a very narrow range of high frequencies comprised between 18 kHz and 20 kHz. The center phase plug does not increase the SPL below 18 kHz and above 20 KHz.

In addition, the central phase plug provides limited advantages on the transfer function relative to the fundamental component measured off-axis.

The purpose of the present invention is to eliminate the drawbacks of the prior art by providing a loudspeaker with a phase plug that is compact and at the same time is capable of increasing the SPL in a wider frequency range than the loudspeakers of the prior art, both in axis and off axis with respect to the loudspeaker.

Another purpose is to provide such a loudspeaker with a phase plug that is efficient at high frequencies and capable of minimizing the harmonic distortions.

These purposes are achieved in accordance with the invention with the features of the appended independent claim 1.

Advantageous embodiments of the invention appear from the dependent claims.

Further features of the invention will appear clearer from the following detailed description, which refers to a merely illustrative and therefore non-limiting embodiment thereof, illustrated in the appended drawings, wherein:

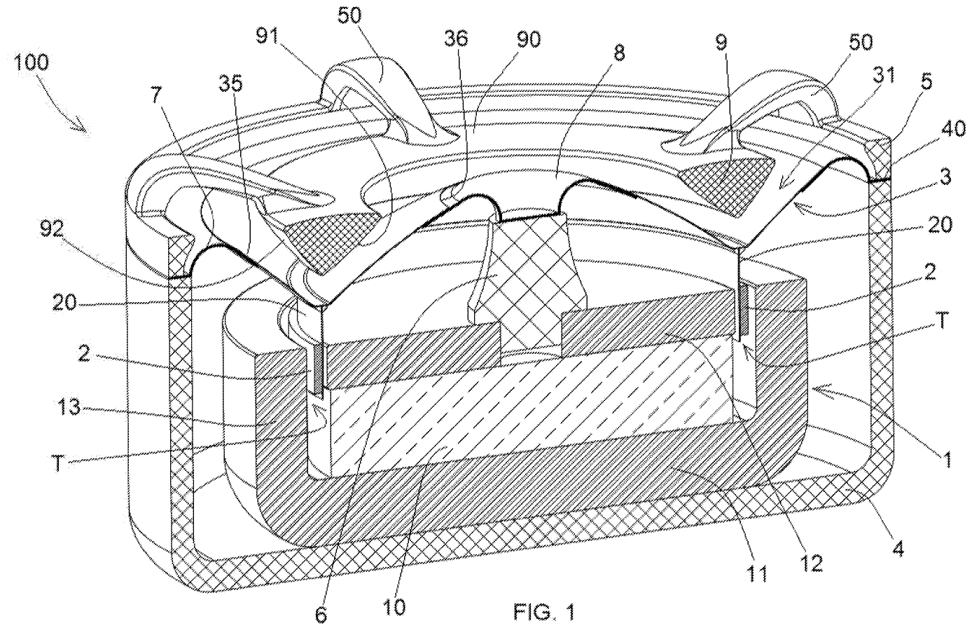

FIG. 1 is a perspective axial view of a loudspeaker with an annular diaphragm with curved V-shape provided with a phase plug according to the invention;

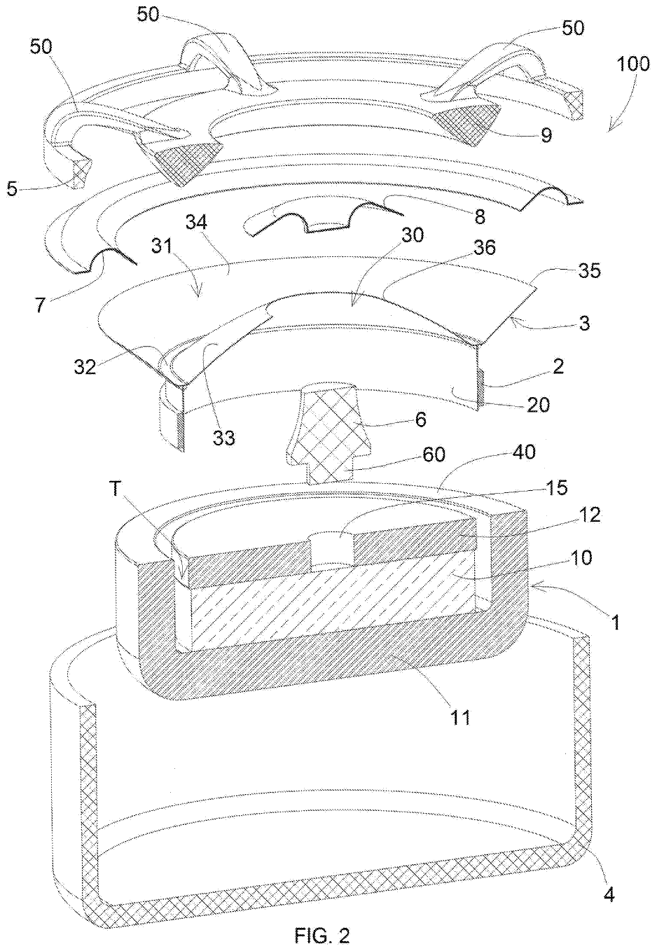

FIG. 2 is an exploded perspective axial view of the loudspeaker of FIG. 1;

FIG. 3 is a diagrammatic view of an annular diaphragm with a straight V-shaped profile, together with a phase plug according to the invention;

FIG. 3A is a diagrammatic axial view taken along the A-A section plane of FIG. 3;

FIG. 3B is a detail enclosed in the circle B of FIG. 3A;

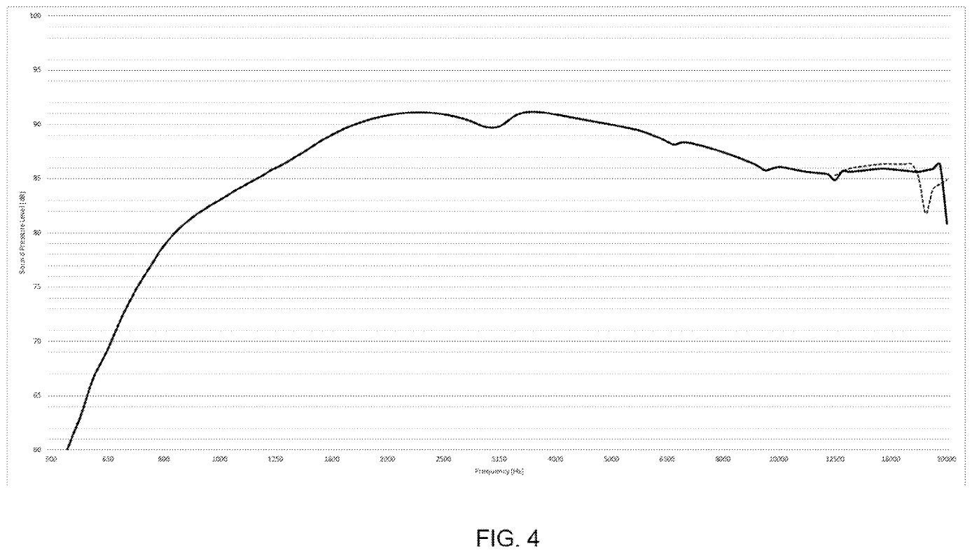

FIG. 4 is a graph illustrating a frequency response in axis to the loudspeaker (SPL as a function of the frequency) for the loudspeaker of FIG. 1 and for the same loudspeaker provided with an annular diaphragm with straight V-shaped profile, shown in FIG. 3, using a multi-physics finite element analysis (FEA) simulation;

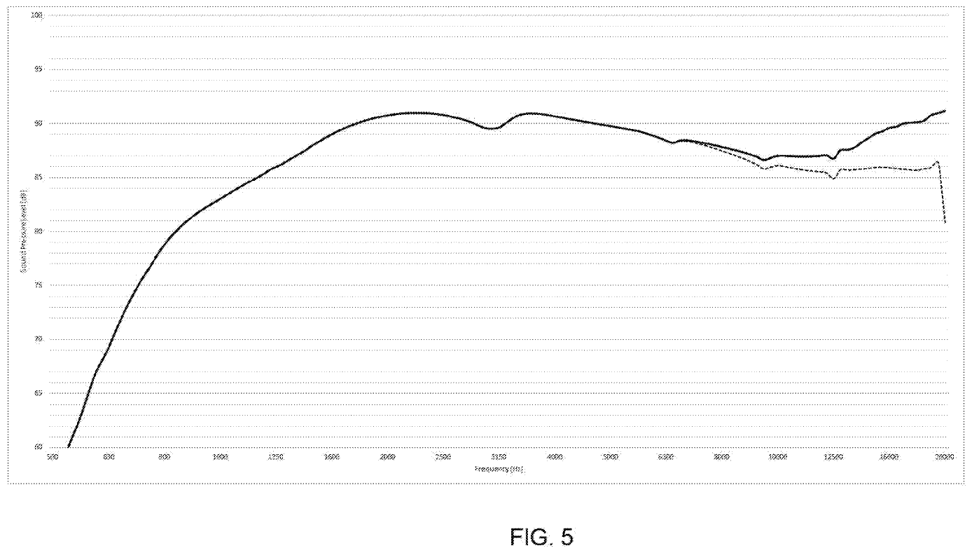

FIG. 5 is a graph illustrating a frequency response in axis to the loudspeaker (SPL as a function of the frequency) for a loudspeaker without a phase plug and for a loudspeaker with a phase plug according to the invention, using a FEA simulation;

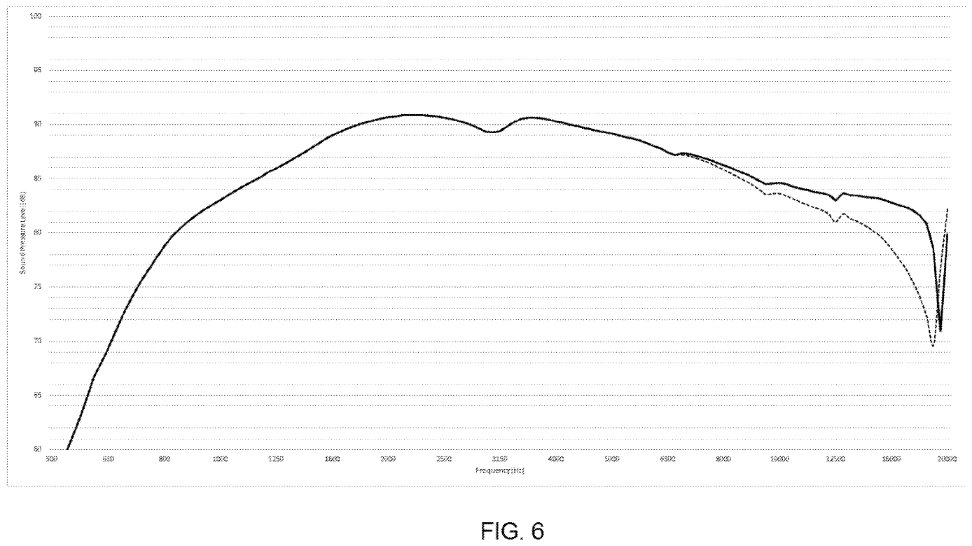

FIG. 6 is a graph illustrating a frequency response of the loudspeaker (SPL as a function of the frequency), in the case of a microphone arranged off axis, with 30° inclination relative to the axis of the loudspeaker, using a FEA simulation, for a loudspeaker without a phase plug and for a loudspeaker with a phase plug according to the invention;

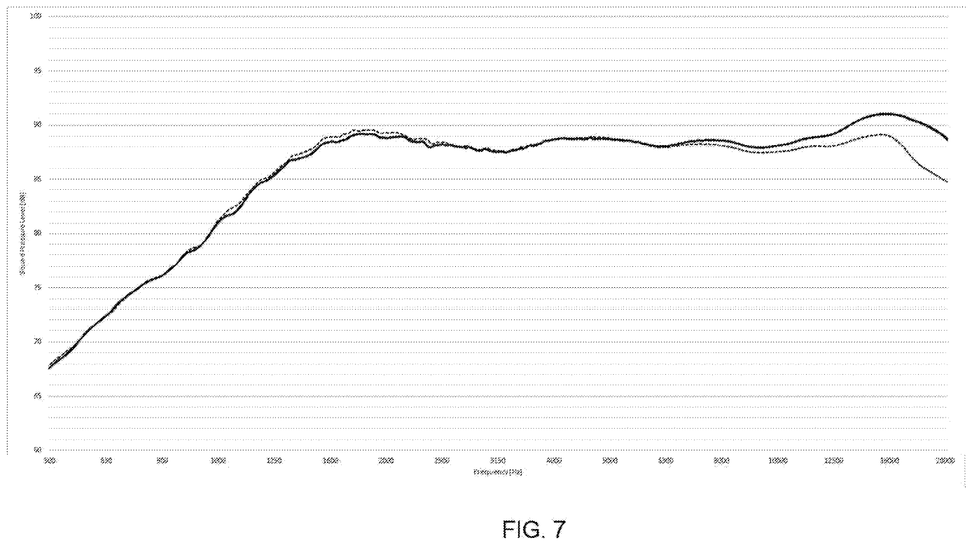

FIG. 7 is a graph illustrating a frequency response in axis to the loudspeaker (SPL as a function of the frequency), using an experimental test, for a loudspeaker without a phase plug (broken line) and for a loudspeaker with a phase plug according to the invention (solid line);

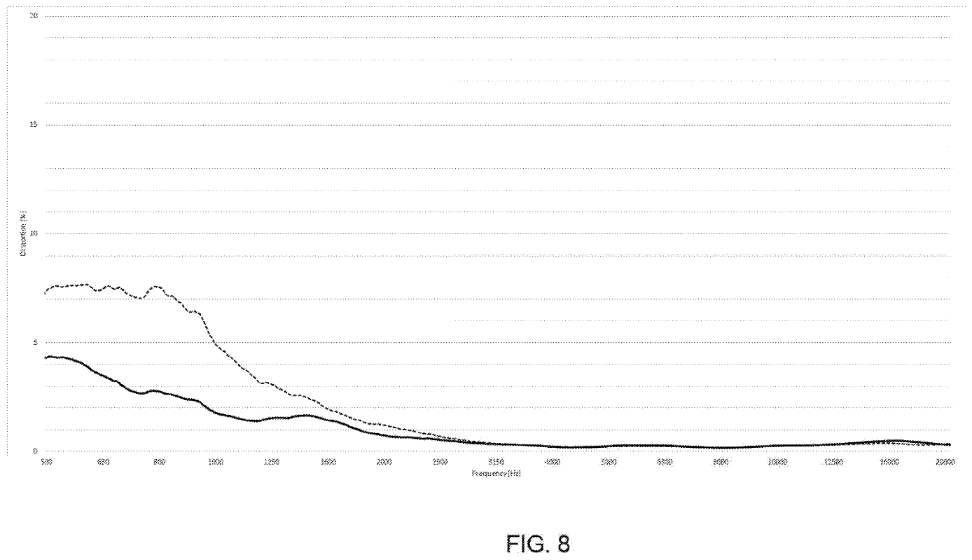

FIG. 8 is a graph illustrating the total harmonic distortion (THD) in frequency in axis to the loudspeaker (THD percentage as a function of the frequency) relative to the graph of FIG. 7, using an experimental test;

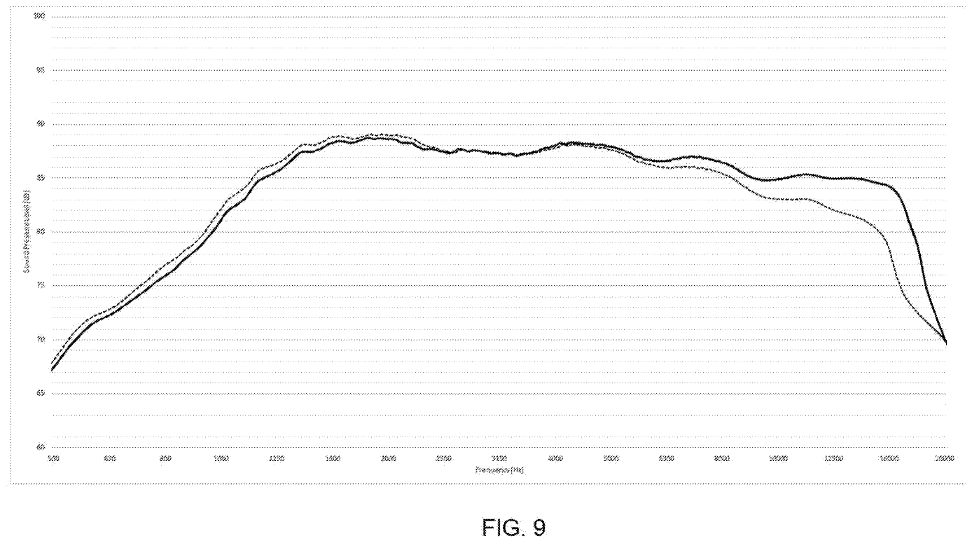

FIG. 9 is a graph illustrating a frequency response of the loudspeaker (SPL as a function of the frequency) in the case of a microphone arranged off axis, with 30° inclination relative to the axis of the loudspeaker, using an experimental test, for a loudspeaker without a phase plug (broken line) and for a loudspeaker with a phase plug according to the invention (solid line); and

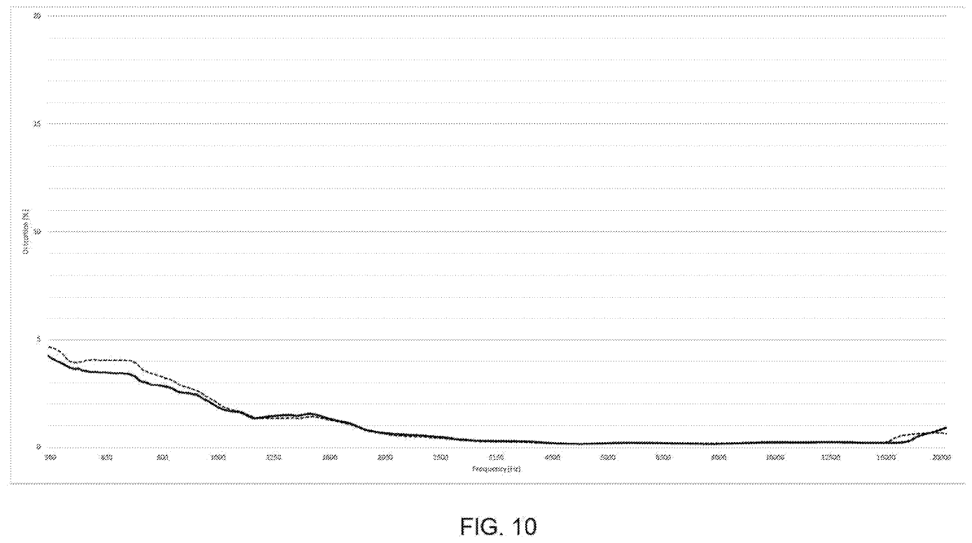

FIG. 10 is a graph illustrating the THD percentage as a function of the frequency relative to the graph of FIG. 9, using an experimental test.

With reference of the Figures, a loudspeaker according to the invention is described, which is comprehensively denoted with reference numeral 100.

The loudspeaker (100) comprises a magnetic assembly (1). The magnetic assembly (1) comprises a magnet (10) arranged between a lower polar plate (11) and an upper polar plate (12). The lower polar plate (11) has a cup-shape (U-shape in axial section) with a cylindrical side wall (13). The magnet (10) and the upper polar plate (12) have a discoidal shape and are housed in the lower polar plate (11) with clearance, so as to leave an air gap (T) with annular shape between the lateral surface (13) of the lower polar plate and the upper polar plate (12) superimposed onto the magnet (10).

A voice coil (2) is wound in a cylindrical support (20) generally made of a metallic material, such as aluminum or titanium, or of a plastic material, such as Polyimide (PI) or fiberglass. The voice coil (2) is arranged in the air gap (T) so that it can move in the air gap (T).

The cylindrical support (20) is connected to a diaphragm (3) in such a way to protrude inferiorly from the diaphragm (3). The diaphragm (3) is an annular diaphragm, i.e. the diaphragm (3) is open in the center and is provided with a central hole (30). Thus, the diaphragm (3) has an outer edge (35) and an inner edge (36) around the central hole (30).

The diaphragm (3) is very thin and resistant and is made of aluminum foil, fabric, such as processed silk, or plastic film.

With reference to the Figures, when viewed from above, the diaphragm (3) has a concave annular shape, meaning that the diaphragm has an annular channel (31) having a base (32), a first wall (33) extending from the base (32) to the inner edge (36) around the central hole (30), and a second wall (34) extending from the base (32) to the outer edge (35).

In FIGS. 1 and 2, when viewed from above, the first wall (33) and the second wall (34) of the diaphragm have a curved convex shape. In addition, the first wall (33) and the second wall (34) have a different length.

Referring to FIGS. 3A and 3B, when viewed in axial section, the annular channel (31) has a shape that can be substantially described as a V-shape (hence the term “V-shaped”) with the vertex cut off at the base (32) of the channel, i.e. a shape of a triangle with base angles (α1, α2) of 30°-50°, preferably 35°-45°. An angle (γ) of 80°-100°, preferably 93°, is provided between the first wall (33) and the second wall (34).

The annular channel (31) has a depth (H) equal to the height of the triangle generated by the section of the annular channel. Although FIGS. 3A and 3B show a diaphragm shaped like an isosceles triangle, such a triangle may not be isosceles and the sides of the triangle may have a different length and may be curved, not straight.

The cylindrical support (20) of the voice coil has an upper edge (21) attached to the base (32) of the annular channel of the diaphragm (3). In such a way, the cylindrical support (20) of the voice coil is arranged axially with respect to the diaphragm (3).

The magnetic assembly (1) is arranged in a basket (4) shaped like a cup that is open on top. The basket (4) has an upper edge (40). An upper ring (5), which is an integral part of the basket, is mounted on the upper edge (40) of the basket.

A central support (6) is mounted on the upper polar plate (12), protruding superiorly and axially from the upper polar plate. The central support (6) has a truncated conical shape. A tang (60) protrudes inferiorly from the central support to be concentrically engaged in a hole (15) of the upper polar plate (12).

The central support (6) is made of a plastic material, such as polycarbonate, possibly with the addition of acrylonitrile-butadiene-styrene (ABS).

A peripheral edge (7) connects the upper ring (5) of the basket to the outer edge (35) of the diaphragm. When viewed from above, the peripheral edge (7) has a convex annular shape.

A central edge (8) connects the central support (6) to the inner edge (36) of the diaphragm around the central hole (30) of the diaphragm. When viewed from above, the central edge (8) has a convex annular shape.

In such a way, the diaphragm (3) vibrates as a result of the axial movement of the voice coil (2) in the air gap and thus the loudspeaker generates a sound.

The central support (6) and the basket (4) have the purpose of supporting the diaphragm (3). The shape and the volume of the central support (6) and of the basket (4) affect the volume of a harmonic chamber under the diaphragm (3) and therefore also affect the frequency response of the loudspeaker.

The loudspeaker (100) comprises a phase plug (9) having an annular shape. The phase plug (9) is arranged in the annular channel (31) of the diaphragm so as not to interfere with the movement of the diaphragm (3). The function of the phase plug (9) is to compress and phase the acoustic wave generated by the vibration of the diaphragm (3), so as to achieve a better performance in terms of SPL at high frequencies.

The phase plug (9) is made of a plastic material, such as polycarbonate or polycarbonate with the addition of ABS.

The phase plug (9) is supported by a plurality of brackets (50) connected to the upper ring (5) of the basket.

Each bracket (50) is in the form of a curved rigid element that protrudes radially inward from the upper ring (5) of the basket.

The basket (4), the upper ring (5) and the brackets (50) may be made of plastic for economic convenience purposes. However, in order to favor the dissipation of the heat generated by the magnetic assembly (1), the basket (4), and possibly also the upper ring (5) and the brackets (50) may be made of a thermally conductive material, such as aluminum. In such a case, it is possible to achieve a higher dissipation of the heat produced by the voice coil (2) that is propagated mainly by conduction through the magnetic assembly (1), reducing the overheating of the loudspeaker and obtaining a higher average power of the loudspeaker.

Referring to FIG. 3A, the thickness (h) of the phase plug (9) is lower than the depth (H) of the annular channel (31) of the diaphragm. Thus, the phase plug (9) does not occupy any space above the diaphragm (3) and therefore it does not increase the thickness in the axial direction of the loudspeaker. By way of example, the thickness (h) of the phase plug may be approximately 0.6-0.8 the depth (H) of the channel of the diaphragm; therefore, the difference between the depth (H) of the channel of the diaphragm and the thickness of the phase plug may be comprised in the range of 0.5-1.2 cm.

When viewed in axial section, the phase plug (9) has a diagrammatically triangular shape with a base (90) and two sides (91, 92). As shown in FIGS. 1 and 2, if the diaphragm has curved walls, the sides (91, 92) of the phase plug will be curved like the walls (33, 34) of the diaphragm, and will not be straight.

Referring to FIG. 3B, the base angles (β1, β2) of the triangle generated by the section of the phase plug are higher by 20%-30%, preferably 25%, than the respective base angles (β1, β2) of the triangle generated by the section of the annular channel (31) of the diaphragm and defined by the first wall (33) and by the second wall (34) of the diaphragm. Therefore, the base angles (β1, β2) of the triangle of the section of the phase plug are 40°-60°, preferably 45°-55°, compared to the base angles (β1, β2) of the annular channel (31) of the diaphragm, which are 30°-50°, preferably 35°-45°. The base (90) of the phase plug is arranged at the base of the triangle generated by the section of the annular channel (31) of the diaphragm. The brackets (50) of the basket are connected to the base (90) of the phase plug.

The sides (91, 92) of the phase plug are respectively inclined to the first wall (33) and to the second wall (34) of the diaphragm by angles (β1, β2) comprised between 7° and 15°, preferably 11°.

The inclination of the sides (91, 92) of the phase plug with respect to the walls (33, 34) of the diaphragm is such to form a mathematical progression with hyperbolic expansion.

FIG. 4 illustrates the result of an FEA simulation regarding the difference between the frequency response of a loudspeaker with an annular diaphragm with straight V-shaped profile (broken line) and with curved V-shaped profile (solid line).

FIG. 5 illustrates the result of an FEA simulation regarding the frequency response of a loudspeaker with an annular diaphragm without a phase plug and with a phase plug. The broken line illustrates the SPL as a function of the frequency in a loudspeaker without a phase plug. The solid line illustrates the SPL as a function of the frequency of the same loudspeaker with the phase plug according to the invention.

As clearly shown by the graph of FIG. 5, at frequencies comprised between 7 kHz and 20 kHz, the loudspeaker with a phase plug has a better frequency response (as SPL) than a loudspeaker without a phase plug.

FIG. 6 illustrates the result of an FEA simulation performed on a loudspeaker with an annular diaphragm without a phase plug and with a phase plug. The test was performed by placing a microphone on an axis inclined by 30° relative to the axis of the loudspeaker and measuring the SPL in decibels detected by the microphone. The broken line illustrates the measurement of the SPL as a function of the frequency of a loudspeaker without a phase plug. The solid line illustrates the measurement of the SPL as a function of the frequency of the same loudspeaker with the phase plug according to the invention.

As clearly shown in the graphs of FIGS. 7 and 9, the experimental tests that were performed on a sample constructed based on the FEA study have confirmed the results of FIGS. 5 and 6 obtained from the FEA simulations. In addition, the solid lines of the graphs of FIGS. 8 and 10 show that the annular phase plug does not increase the THD level, whereas it significantly increases the SPL.

Thus, a loudspeaker with an annular phase plug according to the invention has a better frequency response in the frequency range comprised between 7 and 20 kHz, that is to say, in a much wider frequency range than the 18-20 KHz range obtained with the loudspeakers of the prior art provided with a central phase plug.

Equivalent modifications may be made to the present embodiment of the invention, within the scope of a person skilled in the art, without departing from the scope of the invention as expressed by the appended claims.

1. A loudspeaker comprising:
a magnetic assembly defining an air gap;
a basket containing said magnetic assembly;
a voice coil arranged in the air gap;
a cylindrical support supporting the voice coil;
a diaphragm connected to said cylindrical support of the voice coil, said diaphragm being annular and having an outer edge connected to the basket and an inner edge around a central hole connected to a central support arranged on said magnetic assembly;
wherein said diaphragm has an annular channel of concave shape when viewed from above; and
wherein said loudspeaker comprises a phase plug with annular shape arranged in the annular channel of the diaphragm so as not to interfere with the movement of the diaphragm.

2. The loudspeaker of claim 1, wherein the phase plug has a thickness lower than a depth of the annular channel of the diaphragm, so that the phase plug does not occupy any space above the diaphragm.

3. The loudspeaker of claim 2, wherein the difference between the depth of the annular channel of the diaphragm and the thickness of the phase plug and is 0.5-1.2 cm.

4. The loudspeaker of claim 1, wherein said annular channel of the diaphragm comprises a base, a first wall extending from the base to the inner edge around the central hole, and a second wall extending from the base to the outer edge, said cylindrical support of the voice coil being attached to said base of the annular channel of the diaphragm so as to protrude inferiorly and axially from the diaphragm.

5. The loudspeaker of claim 4, wherein the annular channel of the diaphragm has a substantially V-shape in axial section, with the vertex cut off at the base of the channel.

6. The loudspeaker of claim 5, wherein the annular channel of the diaphragm has a triangular shape in axial section, with base angles of 30°-50° of said triangle.

7. The loudspeaker of claim 6, wherein the phase plug has a substantially triangular shape in axial section.

8. The loudspeaker of claim 7, wherein the phase plug has a base facing upward and two sides converging downward.

9. The loudspeaker of claim 8, wherein the base angles of the triangle generated by the section of the phase plug are higher by 20%-30% than the respective base angles of the triangle generated by the section of the annular channel of the diaphragm and defined by the first wall and by the second wall.

10. The loudspeaker of claim 9, wherein the sides of the phase plug are inclined relative to the first wall and to the second wall of the diaphragm, respectively, and the inclination of the sides of the phase plug relative to the walls of the diaphragm is such as to form a mathematical progression with hyperbolic expansion.

11. The loudspeaker of claim 1, wherein said phase plug is supported by a plurality of brackets connected to an upper ring of the basket.

12. The loudspeaker of claim 11, wherein each bracket is in the form of a curved rigid element protruding radially inward from the upper ring of the basket.
